(19) United States
(12) Patent Application Publication
(10) Pub. No.: US 2026/0157382 A1
(43) Pub. Date: Jun. 11, 2026

(54) A Container for Revitalizing and Extending the Shelf-Life of Food

(71) Applicant: Magnus MUMBY, Huddersfield West Yorkshire (GB)

(72) Inventor: Magnus MUMBY, Huddersfield West Yorkshire (GB)

(21) Appl. No.: 18/876,762

(22) PCT Filed: Jun. 20, 2022
(86) PCT No.: PCT/IB2022/055692

§ 371 Date: Dec. 19, 2024

(51) Int. Cl. A23B 2/717; A23B 7/148; B65D 81/26

(52) U.S. Cl. CPC A23B 2/717; A23B 7/148; B65D 81/264

(57) ABSTRACT

The present invention is directed to a foodstuff package for receiving the foodstuff and a method for revitalising the foodstuff placed therein.

### FIELD OF APPLICATION OF THE INVENTION

The present invention relates to a container for revitalising and extending the shelf-life of food. The present invention further relates to a method for revitalising and extending the shelf-life of food.

### BACKGROUND TO THE INVENTION

Absorbent pads and other devices and/or means are used in conjunction with containers in the food industry to absorb excess moisture and other unwanted compounds released by food. The food is typically placed on the aforementioned pad and enclosed in a container or similar device. The absorbent pads typically comprise activated carbon, ethylene absorbent material, or similarly-suited materials that allow for the shelf-life of the food to be extended. However, such absorbent pads are typically single-use only.

Other devices, such as oxygen absorbers—small packets that contain iron powder—physically remove the oxygen from the atmosphere in a container and will kill adult insects and prevent larval insects from surviving. They are made of a material that allows oxygen and moisture to enter but does not let the iron powder leak out. The moisture in the food causes the iron to rust. As it oxidises, the iron absorbs oxygen.

The art teaches of a plethora of containers and other types of devices for extending the shelf-life of fresh foods, in particular fresh fruits and vegetables.

One such container is described in U.S. Pat. No. 9,364,119 which discloses a food storage container including an absorbent pad having an active agent for preserving the freshness of food products. This food storage container, however, does not include any means for revitalising food products that have wilted or expired.

Another example is disclosed in US Patent No 2011/0243483 whereby a single-use container includes an oxygen scavenger and a filter for extending the shelf-life of ingestible material. Once again however, this invention does not include any means for revitalising food products that have wilted or expired.

Ordinary Tupperware containers are also used to preserves fruits and vegetables. The approximate amount of time that fresh fruit and vegetables can be preserved is for five to six days.

Containers of the type described herein above and devices for preserving food produce are utilised in the retail industry where such a sector typically contributes upwards of 14% of a country's gross domestic product (GDP).

According to sources, it is indicated that food wastage totals approximately 1.4 billion tons of food annually; the United States being the largest contributor thereof with approximately 40 million tons of food wastage each year.¹ This wastage results from various foodstuffs that are not able to be effectively refrigerated and/or stored to be used at a later stage. Users also often buy large amounts of perishable food without the necessary means to preserve the same. Where so possible, such users utilise airtight containers or containers comprising the above mentioned absorbent pads and similar means in order to extend the shelf-life of food. However, such containers are often opened and closed multiple times such that the food contained therein is exposed to ambient conditions, which often results in the food being spoiled. Moreover, most of these containers are only capable of extending the shelf-life of food, while being incapable of improving the quality of food and are not capable of rehydrating and/or revitalising food so as to restore or preserve the food quality. ¹https:/www.environmentalleader.com/2021/05/the-state-of-food-waste-in-america/

Given the above, it is clear that there exists a present need for a container that is capable of not only extending the shelf-life of food but also being capable of revitalising such food.

### Definitions

Revitalise: the ordinary meaning of revitalise is to imbue and object with new life and vitality. With reference to this invention, the term ‘revitalise’ refers to the process or change to foodstuffs in order for it to change its state from wilted or expired, to a foodstuff that is fresh, hydrated, firm and/or robust.

Means: an action, an object or a system by which a result is achieved; a method; a way of achieving or doing something.

### OBJECT OF THE INVENTION

It is accordingly an object of the present invention to provide a container that seeks to, at least partially, overcome or lessen the above disadvantages and/or will be a useful alternative to existing containers and devices for extending the shelf-life of food while simultaneously being capable of revitalising the same.

### SUMMARY OF THE INVENTION

According to a first aspect thereof, there is provided a foodstuff package including:
a container;
the container defining a receiving zone for receiving the foodstuff;
a sealing means for sealing the container;
a method for revitalising the foodstuff placed in the receiving zone is carried out, the method including the steps of:
   submerging the foodstuff in a liquid;
   allowing the foodstuff to absorb the (or at least an amount of the) liquid for a predetermined amount of time;
   displacing the foodstuff to remove excess liquid; and
   placing the foodstuff on an absorbent material to remove a predetermined amount of liquid.

In an embodiment of the invention, the container may comprise a flexible material.

The flexible material may be a polymeric material.

The container may comprise a material selected from the group consisting of glass, ceramic, a polymeric material, and combinations thereof.

The receiving zone may comprise an absorbent material.

The absorbent material may be an absorbent pad.

The absorbent pad may be capable of performing a function selected from the group consisting of antimicrobial, a CO₂ generator, an O₂ scavenger, an ethylene scavenger, and a combination thereof.

The absorbent material is locatable in the container having means for regulating and controlling the humidity therein.

The foodstuff package may include adjustment means for adjusting the humidity in the container.

The foodstuff package may include adjustment means for adjusting the temperature in the container.

The sealing means may comprise a flexible material.

The sealing means may be a polymeric material.

The sealing means may seal the container such that it creates an enclosed environment.

The enclosed environment may prevent the passage of normal atmospheric air in the foodstuff package.

The enclosed environment may be isobaric.

The sealing means may be used to control the relative humidity in the foodstuff package.

The foodstuff package may comprise filtration means for filtering air in the container. The foodstuff may be selected from the group consisting of coffee, tea, cocoa, milk products, meat, poultry, seafood, produce, vegetables, fruit, fresh greens, and a combination thereof.

The liquid may be water.

The liquid may be a mixture of water and additional compounds.

The additional compounds may be selected from the group consisting of nutrients, vitamins, antimicrobial compounds, minerals, lipids, carbohydrates, proteins, amino acids, and a combination thereof.

According to a second aspect thereof, there is provided a method for revitalising a foodstuff, the method including the steps of:
submerging the foodstuff in a liquid;
allowing the foodstuff to absorb the liquid for a predetermined amount of time;
displacing the foodstuff to remove excess liquid; and
placing the foodstuff on an absorbent material to remove a predetermined amount of liquid, wherein the absorbent material is locatable in a container having means for regulating and controlling the humidity therein.

The above and other characteristics, features and advantages of the present invention will become apparent from the following detailed description, taken in conjunction with the accompanying drawing which illustrate, by way of example, the principles of the invention. This description is given for the sake of example only, without limiting the scope of the invention. The reference figures quoted below refer to the attached drawings.

### BRIEF DESCRIPTION OF THE DRAWINGS

Preferred embodiments of the invention are described below with reference to the accompanying figures, wherein:

FIG. 1 is a schematic perspective view of a foodstuff placed into a foodstuff package in order to revitalise the foodstuff;

FIG. 2 is a schematic perspective view of a foodstuff placed into a foodstuff package in order to revitalise the foodstuff;

FIG. 3 provides a series of photographs of expired lettuce that has been revitalised over 24 hours;

FIG. 4 provides a series of photographs of expired lettuce that has been revitalised and wherein the freshness is preserved for 14 days by subjecting the expired lettuce to the method illustrated and described in FIGS. 1 and 2 and placing the same in the foodstuff package;

FIG. 5 provides a series of photographs of expired herbs that have been revitalised over 24 hours; and

FIG. 6 provides a series of photographs of expired herbs that have been revitalised and wherein the freshness is preserved for 14 days by subjecting the expired herbs to the method illustrated and described in FIGS. 1 and 2 and placing the same in the foodstuff package;

The presently disclosed subject matter will now be described more fully hereinafter with reference to the accompanying Examples, in which representative embodiments are shown. The presently disclosed subject matter can, however, be embodied in different forms and should not be construed as limited to the embodiments set forth herein. Rather, these embodiments are provided so that this disclosure will be thorough and complete, and will fully convey the scope of the embodiments to those skilled in the art.

### DESCRIPTION OF PREFERRED EMBODIMENTS OF THE INVENTION

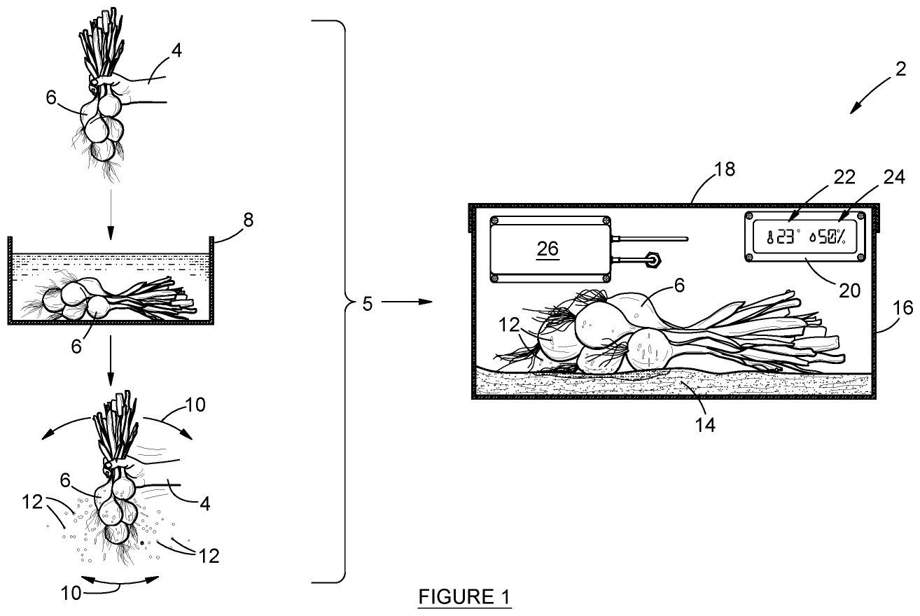

Non-limiting examples of a preferred embodiment of the invention is described in more detail below, with reference to FIG. 1 to FIG. 6.

### Example 1

With reference to FIG. 1, there is provided a foodstuff package 2 wherein a user 4 performed a method 5 in order to prepare a foodstuff 6. The foodstuff 6 is submerged in a liquid medium 8 for a predetermined time such that the foodstuff 6 absorbs a predetermined amount of the liquid. Following the foodstuff 6 being submerged, the user 4 shakes and/or displaces 10 the foodstuff 6 in order to remove 12 any excess liquid located on a surface region of the foodstuff 6. In an alternative to the method 5, a user 4 could place the foodstuff 6 in a colander (not shown) for approximately 30 minutes to drain any excess liquid.

Following completion of the method 5, the foodstuff 6 is placed on an absorbent material 14 located inside a container 16 sealed with a lid 18, wherein the same ensures an airtight environment inside of the container 16. Once placed on the absorbent material 14, any excess liquid is removed 12 from the foodstuff 6. A measurement device 20 is further provided inside of the container 16 in order to measure the temperature 22 and humidity 24 inside of the container 16.

Controlling means 26 are also provided on a surface region of the container 16 for controlling the humidity and temperature inside of the container 16. Importantly, controlling and adjusting the humidity and temperature in the container allows for the foodstuff 6 to be revitalised and extension of the shelf-life thereof.

Preferably, the foodstuff 6 is placed on the absorbent material 14 within the container 16 having been sealed in an airtight configuration with the lid 18. The controlling means 26 is then utilised to cool the temperature to a value between 0 and 10° C. for a time period varying from 12 to 24 hours, depending on the composition of the foodstuff 6.

It will be appreciated to a person skilled in the art that the measurement device 20 and the controlling means 26 are not required for the foodstuff package 2. Utilising the method 5 together with conditions inside of the container 16, namely excess liquid, temperature and humidity, allows for the shelf-life of the foodstuff 6 to be extended in addition to revitalising the foodstuff 6. To this end, we provide some example images below:

### Example 2

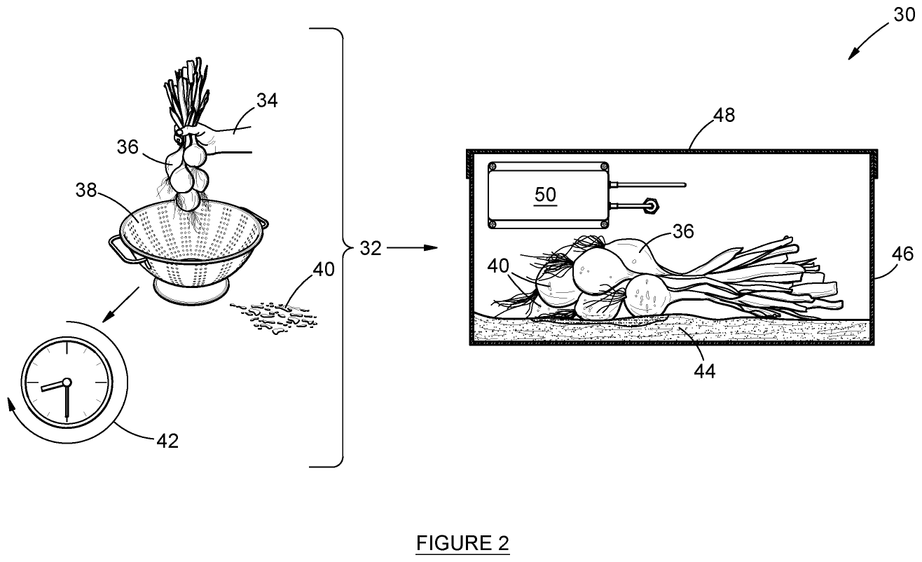

With reference to FIG. 2, there is provided a foodstuff package 30 including a method 32 including the steps of a user 34 washing 35 a foodstuff 36 in a liquid and thereafter placing the foodstuff 36 in a colander 38 to drain any excess liquid 40. The foodstuff 36 is placed in the colander 38 for a time period 42 of approximately 30 minutes.

Following the method 32, the foodstuff 36 is placed on an absorbent material 44 located inside a container 46 sealed with a lid 48, wherein the same ensures an airtight environment inside of the container 46. Once placed on the absorbent material 44, any excess liquid is removed 40 from the foodstuff 36.

Controlling means 50 are also provided on a surface region of the container 46 for controlling the humidity and temperature inside of the container 46. Preferably, the foodstuff 36 is placed on the absorbent material 44 within the container 46 having been sealed in an airtight configuration with the lid 48. The controlling means 50 is then utilised to cool the temperature to a value between 0 and 10° C. for a time period varying from 12 to 24 hours, depending on the composition of the foodstuff 36.

### Example 3

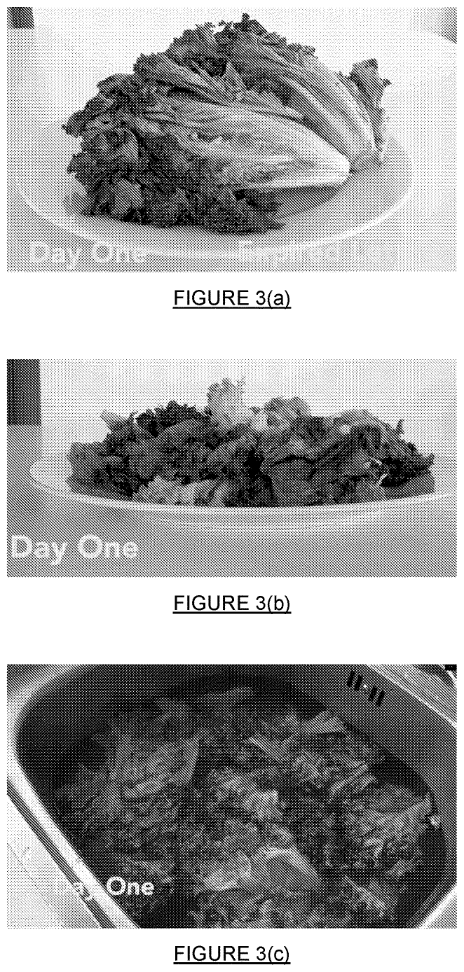

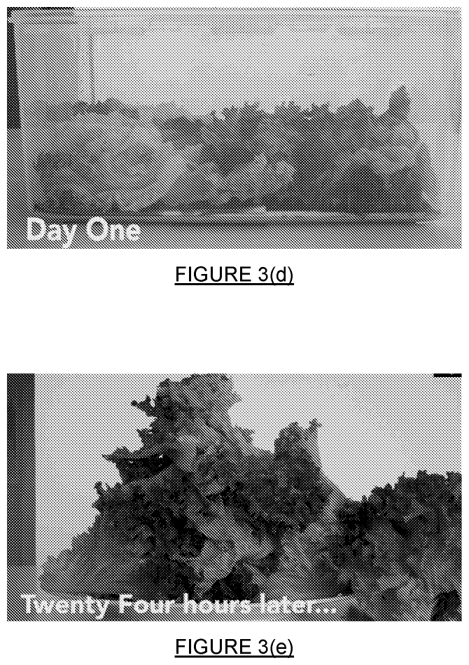

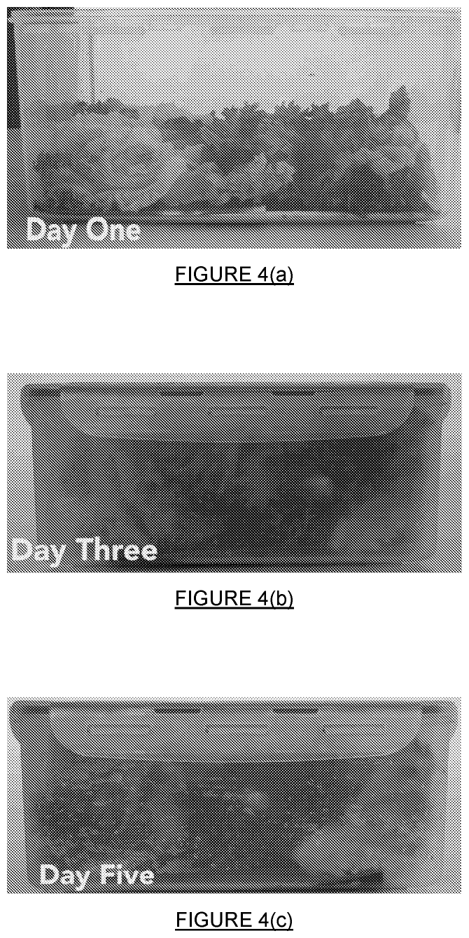

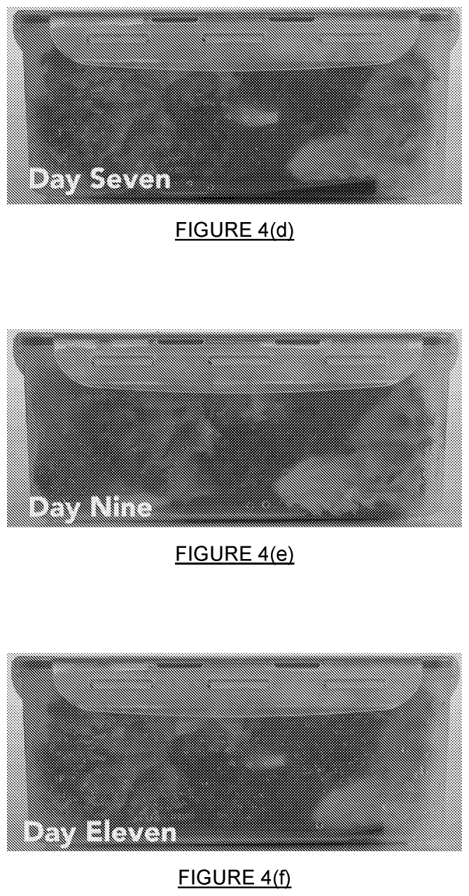

With reference to FIG. 3, there is provided a top view of a plate of expired lettuce 3(a) and a side view 3(b). As illustrated in FIGS. 1 and 2, the expired lettuce is submerged in a liquid medium 3(c) for a predetermined time such that the expired lettuce absorbs a predetermined amount of the liquid. A user then shakes and/or displaces the expired lettuce in order to remove any excess liquid located on a surface region thereof and places the expired lettuce in the foodstuff package 3(d). After 24 hours, the expired lettuce has been revitalised as illustrated in 3(e).

### Example 4

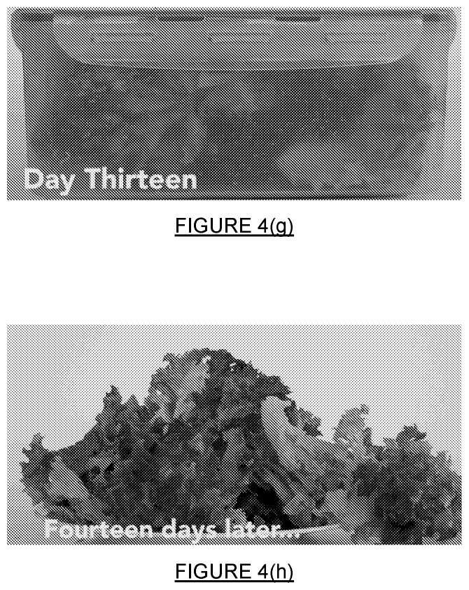

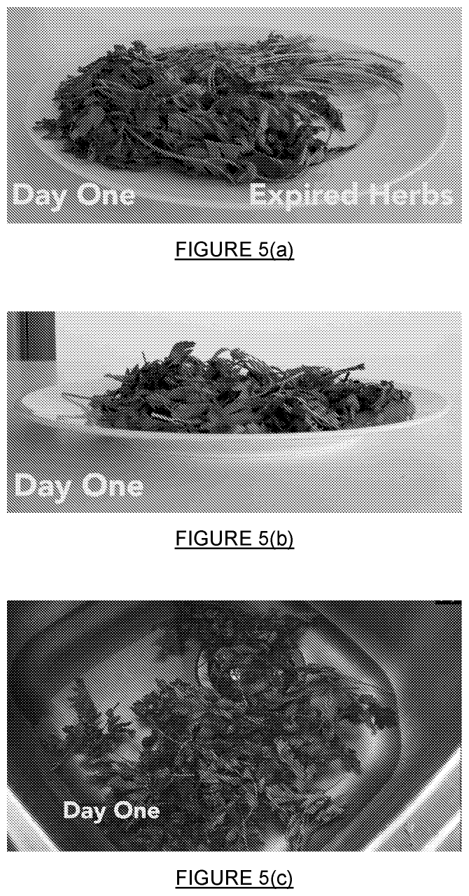

With reference to FIG. 4, there is provided expired lettuce that has been subjected to the method described in FIGS. 1 and 2. The expired lettuce is then placed in the foodstuff package for 14 days, wherein the revitalised state and maintenance thereof is illustrated in FIG. 4(a) to FIG. 4(h).

Upon inspection of FIG. 4(a) and FIG. 4(b), it is clear that the expired lettuce has been revitalised. More particularly, visual inspection clearly shows that expired lettuce in FIG. 4(a) only fills half (or partially fills) the foodstuff package, while the expired lettuce in FIG. 4(b) has been revitalised to cover a much larger surface area of the container; the lettuce is noted to now fully fill the surface area in the foodstuff package. Moreover, the expired lettuce is not only shown to be revitalised once subjected to the method, but it also maintains its revitalised state for 14 days when placed and stored in the foodstuff package. As is clearly illustrated upon comparing the expired lettuce in FIG. 4(h) to the expired lettuce in FIG. 4(a), the expired lettuce has not only been revitalised by the method, but the time as regards to its revitalised state has been extended by 14 days by placing it in the foodstuff package. Notably and as one could expect, placing fresh lettuce in the foodstuff package would also extend the freshness (crispness) thereof beyond its typical lifespan when not placed in the foodstuff package.

### Example 5

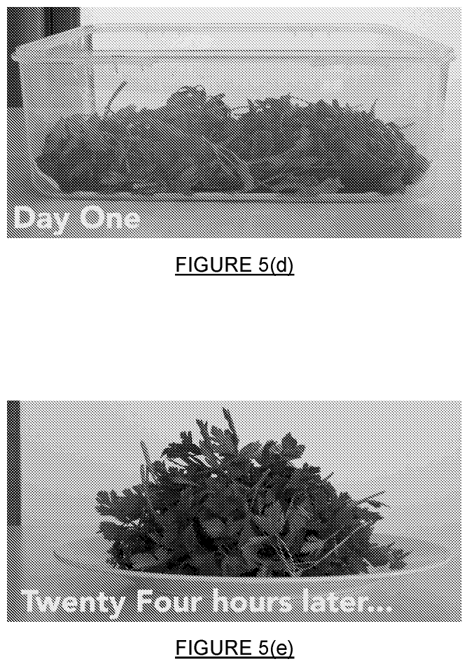

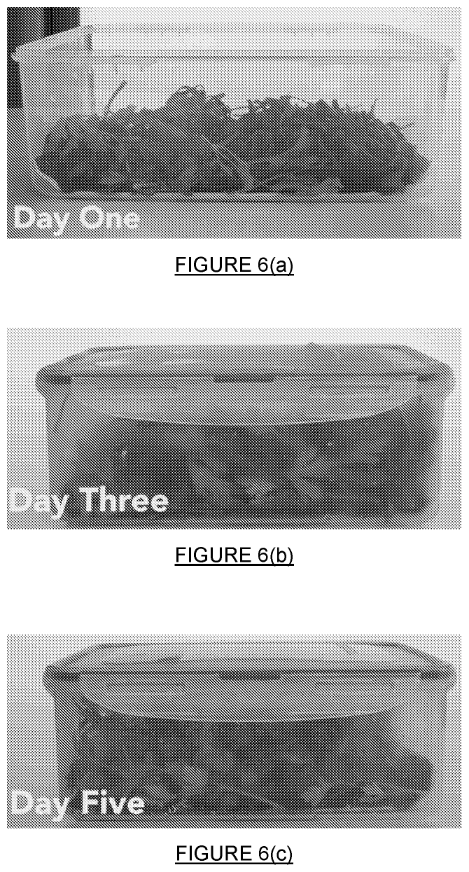

With reference to FIG. 5, there is provided a top view of a plate of expired herbs 5(a) and a side view 5(b). As illustrated in FIGS. 1 and 2, the expired herbs are submerged in a liquid medium (5c) for a predetermined time such that the expired herbs absorb a predetermined amount of the liquid. A user then shakes and/or displaces the expired herbs in order to remove any excess liquid located on a surface region thereof and places the expired herbs in the foodstuff package 5(d). After 24 hours, the expired herbs have been revitalised as illustrated in 5(e).

### Example 6

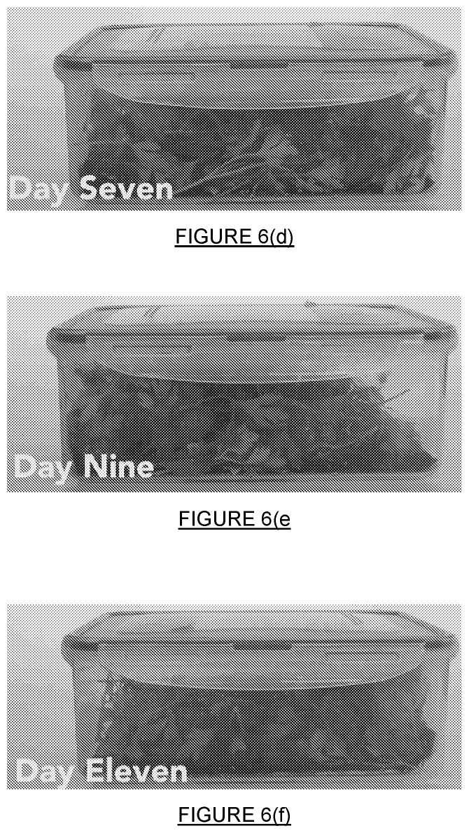

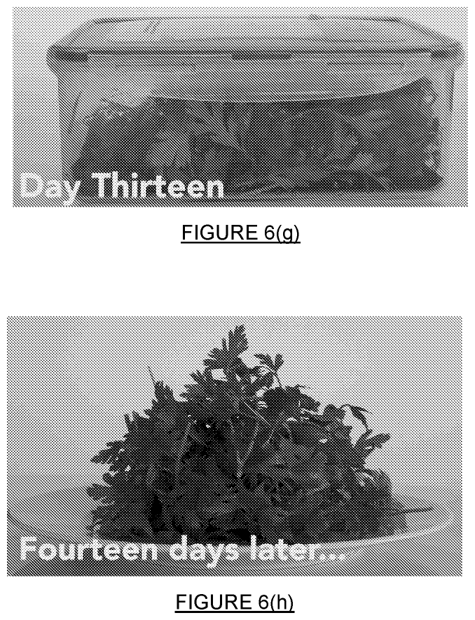

With reference to FIG. 6, there is provided expired herbs that have been subjected to the method described in FIGS. 1 and 2. The expired herbs are then placed in the foodstuff package for 14 days, wherein the revitalised state and maintenance thereof is illustrated in FIG. 6(a) to FIG. 6(h).

Upon inspection of FIG. 6(a) and FIG. 6(b), it is clear that the expired herbs have been revitalised. More particularly, visual inspection clearly shows that the expired herbs in FIG. 6(a) only fills half (or partially fills) the foodstuff package, while the expired herbs in FIG. 6(b) have been revitalised to cover a much larger surface area of the container; the herbs are noted to now fully fill the surface area in the foodstuff package. Moreover, the expired herbs are not only shown to be revitalised once subjected to the method, but they also maintain their revitalised state for 14 days when placed and stored in the foodstuff package. As is clearly illustrated on comparing the expired herbs in FIG. 6(h) to the expired lettuce in FIG. 6(a), the expired herbs have not only been revitalised by the method, but the time as regards to their revitalised state has been extended by 14 days by placing them in the foodstuff package. This, in turn, extends the freshness thereof beyond its typical lifespan when not placed in the foodstuff package.

### Surprising and Unexpected Results

From the Figures above, it has been demonstrated that the foodstuff package and method of the present invention not only preserves freshness and extends the shelf-life of one or more foodstuffs, but it allows a user to take expired or wilted foodstuffs and revitalise same. The Applicant submits that the foodstuff package and method described and disclosed herein is the only invention capable of revitalising suitable foodstuff, while also allowing for freshness to be preserved and the shelf-life to be extended.

Moreover, the foodstuff package is ideal for the shipping and transport of produce across the world in order to preserve freshness and extend the shelf-life thereof. Importantly, this will be cost effective and be advantageous to various companies involved in logistics and the transport of large quantities of foodstuffs when compared to conventional methods of achieving the same.

1-20. (canceled)

21. A foodstuff package suitable for use with a foodstuff, the foodstuff package comprising:
(i) a container defining a receiving zone for receiving the foodstuff, wherein the foodstuff is selected from the group consisting of plant produce, vegetables, fruit, herbs, spices, and a combination thereof;
(ii) one or more sealing means for sealing the container, wherein the one or more sealing means creates an enclosed isobaric environment; and
(iii) a method for revitalising the foodstuff placed in the receiving zone, wherein the method comprises the steps of:
(a) temporarily submerging the foodstuff in a liquid;
(b) allowing the foodstuff to absorb the liquid for a predetermined amount of time;
(c) displacing the foodstuff to remove excess liquid; and
(d) placing the foodstuff on an absorbent material, wherein the absorbent material is capable of performing a function selected from the group consisting of antimicrobial, a CO₂ generator, an O₂ scavenger, an ethylene scavenger, and a combination thereof, to remove a predetermined amount of liquid.

22. The foodstuff package of claim 21, wherein the container comprises a material selected from the group consisting of glass, ceramic, a polymeric material, and combinations thereof.

23. The foodstuff package of claim 21, wherein the absorbent material is locatable in the container having means for regulating the humidity therein.

24. The foodstuff package of claim 21, wherein the one or more sealing means comprises a flexible material.

25. The foodstuff package of claim 21, wherein the one or more sealing means is used to control the relative humidity.

26. The foodstuff package of claim 21, wherein the one or more sealing means includes at least one securing means for securing the absorbent material in place within the container.

27. The foodstuff package of claim 21, wherein the liquid is a mixture of water and additional compounds.

28. The foodstuff package of claim 27, wherein the additional compounds is selected from the group consisting of nutrients, vitamins, antimicrobial compounds, minerals, lipids, carbohydrates, proteins, amino acids, and a combination thereof.

29. The foodstuff package of claim 21 including control means for controlling the humidity in the container.

30. The foodstuff package of claim 21 including control means for controlling the temperature in the container.

31. A method for revitalising a foodstuff, the method including the steps of:
temporarily submerging the foodstuff, wherein the foodstuff is selected from the group consisting of plant produce, vegetables, fruit, herbs, spices, and a combination thereof, in a liquid;
allowing the foodstuff to absorb the liquid for a predetermined amount of time;
displacing the foodstuff to remove excess liquid; and
placing the foodstuff on an absorbent material, wherein the absorbent material is capable of performing a function selected from the group consisting of antimicrobial, a CO₂ generator, an O₂ scavenger, an ethylene scavenger, and a combination thereof, to remove a predetermined amount of liquid.

32. The method of claim 31, wherein the absorbent material is locatable in a container having means for regulating and controlling the humidity therein.
